(19) United States
(12) Patent Application Publication
(10) Pub. No.: US 2009/0213953 A1
(43) Pub. Date: Aug. 27, 2009

(54) Bit Log Likelihood Ratio (LLR) Computation of a 32-QAM System

(75) Inventor: HAIYUN YANG, SAN JOSE, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/036,495

(22) Filed: Feb. 25, 2008

(51) Int. Cl. H04L 5/12; H04L 27/38

(52) U.S. Cl. 375/261; 375/341; 375/262

(57) ABSTRACT

A method and apparatus for computing and comparing the LLR of a 32-QAM mapping by splitting the mapping point to a most significant bit and four Least Significant Bits. Forming two groups based upon the characteristic of the most significant bit. Use the characteristics of an associated 16-QAM mapping to compute the four Least Significant Bits of the 32-QAM mapping.

### FIELD OF THE INVENTION

The present invention relates generally digital receivers, more specifically the present invention relates to bit Log Likelihood Ratio (LLR) computation in a digital receiver.

### BACKGROUND

Generally speaking, in a typical digital communication system, a transmitter in based-band includes the forward-error control (FEC) encoder, and on the receiver end a FEC decoder is required. For most of FEC schemes, such as for convolution codes, Turbo codes and low density parity check codes (LDPC); if the input to the FEC decoder is a soft input, Bit Likelihood Ratio (LLR) computation is required. LLR typically requires complicated computation. In order to simplify the circuit logic for LLR computation, improved method and systems are needed.

Using a constellation diagram as a representation of a signal modulated by a digital modulation scheme such as Quadrature Amplitude Modulation (QAM) is known. It is also known to simplify the computation of a set of constellation point on the transmitter side by only storing constellation points in one quadrant of each constellation map rather than storing all the constellation points in each of the constellation maps. See U.S. Pat. No. 6,917,559 to Kang, et al.

For specific QAM system, the lower order QAM may contain all the information of a higher order QAM with pattern exiting therein. Therefore, it is desirable to find a relationship between different QAMs and utilize the relationship to simplify circuit logic and/or computation.

### SUMMARY OF THE INVENTION

A method and system to simplify circuit logic and/or computation in a QAM System is provided.

A method and system to simplify circuit logic and/or computation in a QAM System based upon a lower order QAM constellation is provided.

A method and system to simplify circuit logic and/or computation in a n-QAM System based upon a similar (n−1)-QAM constellation is provided.

A method and system to simplify circuit logic and/or computation in a 32-QAM System is provided.

A method and system to simplify circuit logic and/or computation in a 32-QAM System based upon a similar 16-QAM constellation is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a Block Diagram of Base-Band Transmitter in accordance with some embodiments of the invention.

FIG. 2 is an example of a block diagram of base-band receiver in accordance with some embodiments of the invention.

FIG. 3 is an example of a mapping or constellation diagram for a rectangular 16-QAM system in accordance with some embodiments of the invention.

FIG. 4 is an example of a mapping or constellation diagram for a rectangular 32-QAM system in accordance with some embodiments of the invention.

FIG. 5 is an example of a block diagram to compute LLR for 32-QAM in accordance with some embodiments of the invention.

FIG. 6 is an example of a flowchart for computing the LLR for 32-QAM in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to simplify circuit logic and/or computation in a QAM System based upon a lower order QAM constellation. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of simplify circuit logic and/or computation in a QAM System based upon a lower order QAM constellation described herein. The non-processor circuits may include, but are not limited to, a radio receiver, a radio transmitter, signal drivers, clock circuits, power source circuits, and user input devices. As such, these functions may be interpreted as steps of a method to simplify circuit logic and/or computation in a QAM System based upon a lower order QAM constellation. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

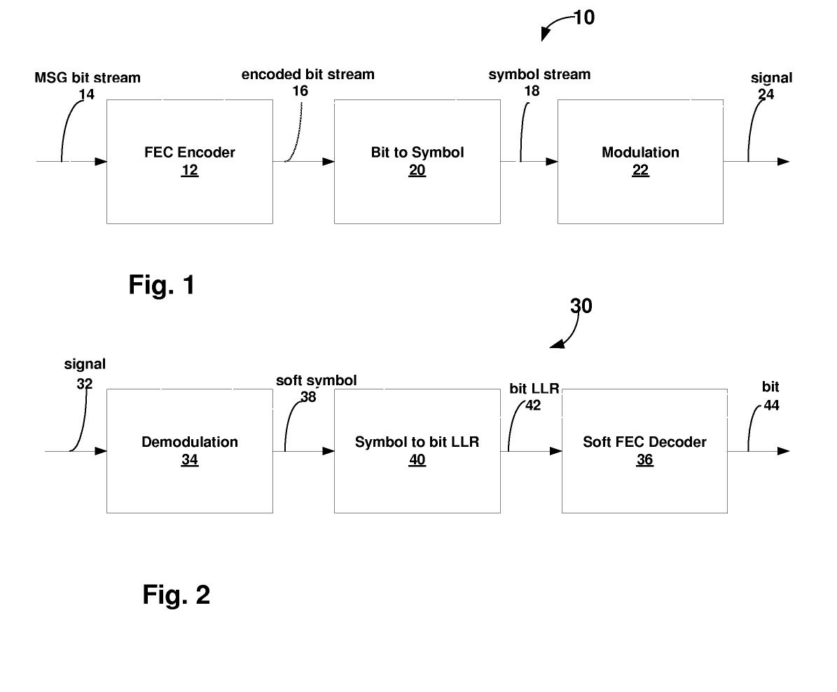

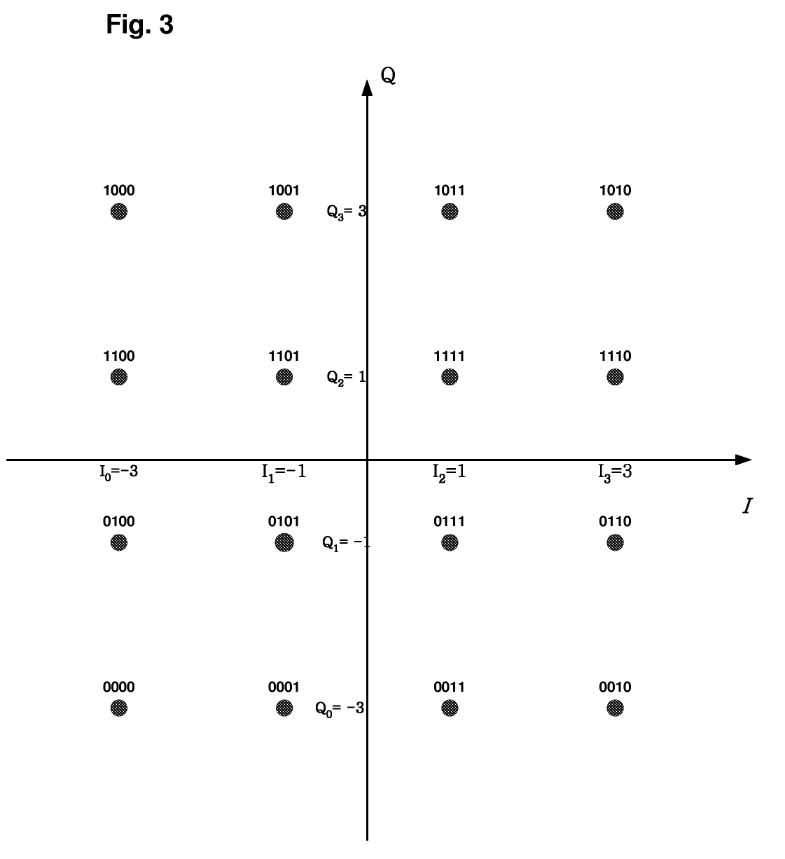

Referring to FIGS. 1-2, a typical digital communication system is shown. At the transmission end 10, a FEC encoder 12 receives a message bit stream 14. FEC encoder 12 output is an encoded serial bit stream 16. Encoded serial bit stream 16 needs to be converted to a symbol stream 18 by a bit-to-symbol converter 20. In turn, each symbol is respectively modulated by modulator 22 in to a signal 24 for transmission down stream. At the receiver end 30, the received signal 32 is first demodulated by a demodulator 34. Then the demodulated output is fed to a FEC decoder. For most of FEC schemes, such as for convolution codes, Turbo codes and low density parity check codes (LDPC); if the input of the FEC decoder is a soft FEC decoder 36, which is actually associated with bit likelihood ratio (LLR), the FEC decoder can achieve better performance. As shown in FIG. 2, the receiver symbol 38 after demodulation 34 is the soft symbol 38. Therefore, a block 40 is required to convert the soft symbol into LLR for each bit or bit LLR 42, which is subjected to soft FEC decoder 36 to arrive at the correct or estimated bit value 44. For detailed description if block 40, see FIGS. 3-6 infra.

LLR Computation for 16-QAM

Referring to FIG. 3, an example of a mapping or constellation diagram for a rectangular 16-QAM system. For the quadrature amplitude modulation (QAM), the complexity of this conversion depends on whether in-phase component (I) and quadrature component (Q) are independent. In determining dependency between the two components, and using 16-QAM as an example, which is shown in FIG. 3, each group of 4 bits, b₃b₂b₁b₀ is mapped to one signal point. Among the four bits, b₁b₀ is mapped to I and b₃b₂ is mapped to Q. The actual mapping rule given by FIG. 3 is

When b₁b₀=00, I=−3;

when b₁b₀=01, I=−1;

when b₁b₀=11, I=+1; and

when b₁b₀=10, I=+3.

Similarly, the same rule applies for Q component, which is not described herein by shown in FIG. 3.

Since I component and Q component are independent during the mapping, the computation of LLR on each receiver bits can be computed easily. Let the received symbol from the demodulation output be (x, y), the LLR of each bit can be computed as follows:

$$\begin{matrix}L L R ( {b}_{i} ) = log \frac{{\sum }_{{b}_{i} = 1} P ( {s}_{I} ( {b}_{i} ) \vert x )}{{\sum }_{{b}_{i} = 1} P ( {s}_{I} ( {b}_{i} ) \vert x )} for {b}_{o} and {b}_{1} & ( 1 ) \\ L L R ( {b}_{i} ) = log \frac{{\sum }_{{b}_{i} = 1} P ( {s}_{Q} ( {b}_{i} ) \vert y )}{{\sum }_{{b}_{i} = 1} P ( {s}_{Q} ( {b}_{i} ) \vert y )} for {b}_{2} and {b}_{3} \\ Where P ( {s}_{i} \vert x ) = \frac{1}{\sqrt{2 π} δ} exp [ - \frac{( {s}_{I} ( {b}_{i} ) - x )}{2 {δ}^{2}} ] \cdot i = 0 , 1 and \\ P ( {s}_{i} \vert y ) = \frac{1}{\sqrt{2 π} δ} exp [ - \frac{{( {s}_{Q} ( {b}_{i} ) - y )}^{2}}{2 {δ}^{2}} ] … i = 2 , 3 & ( 2 )\end{matrix}$$

Using the notation given in FIG. 3, the equations of (1) and (2) can be expressed as

$$L L R ( {b}_{o} ) = log \frac{P ( {I}_{1} \vert x ) + P ( {I}_{2} \vert x )}{P ( {I}_{0} \vert x ) + P ( {I}_{3} \vert x )} \\ L L R ( {b}_{1} ) = log \frac{P ( {I}_{2} \vert x ) + P ( {I}_{3} \vert x )}{P ( {I}_{0} \vert x ) + P ( {I}_{1} \vert x )} \\ L L R ( {b}_{2} ) = log \frac{P ( {Q}_{1} \vert y ) + P ( {Q}_{2} \vert y )}{P ( {Q}_{0} \vert y ) + P ( {Q}_{3} \vert y )} \\ L L R ( {b}_{3} ) = log \frac{P ( {Q}_{2} \vert y ) + P ( {Q}_{3} \vert y )}{P ( {Q}_{0} \vert y ) + P ( {Q}_{3} \vert y )} \\ Where P ( s \vert x ) = \frac{1}{\sqrt{2 π} δ} exp [ - \frac{{( s - x )}^{2}}{2 {δ}^{2}} ] \qquad ( 3 )$$

From Equations (3), we can see the calculation of LLR of b₀ and b₁ depends only on the received I components, and the calculation of LLR of b₂ and b₃ depends only on Q components. Due to this, the calculation of LLR is relatively simple as compared with the cases where the calculation of LLR of bi (i=0, 1, 2, 3) depends on both I and Q components.

LLR Computation for 32-QAM

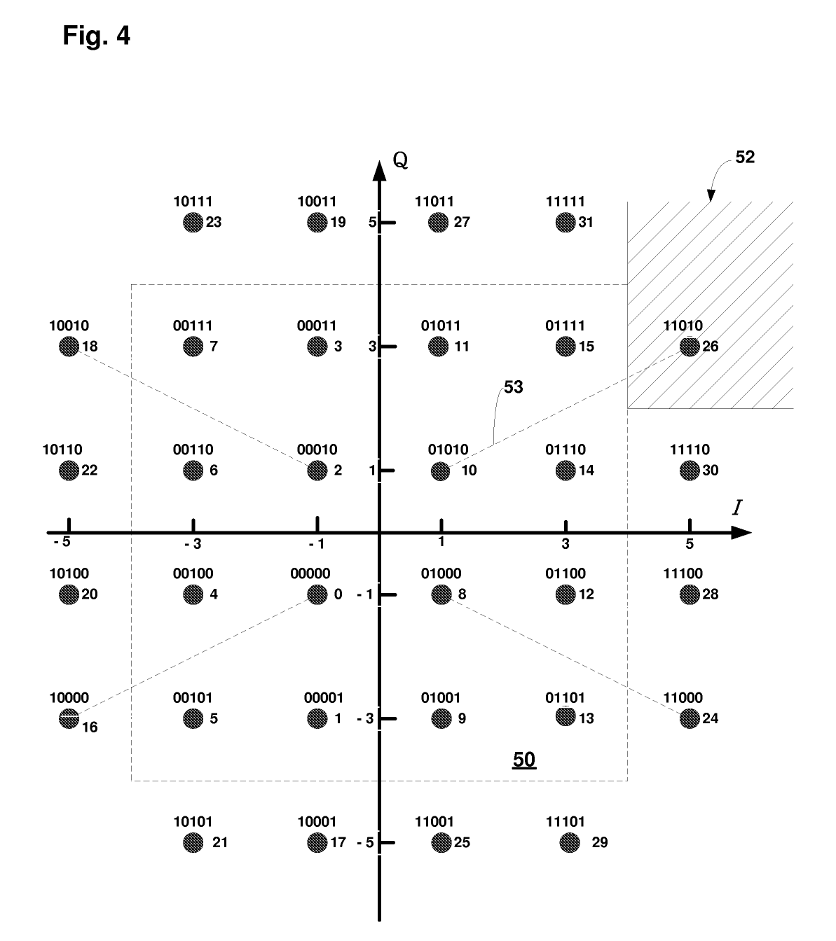

Referring to FIG. 4, an example of a mapping or constellation diagram for a rectangular 32-QAM system is shown. For the mapping of 32-QAM, I and Q components are not independent. In other words, each bit is related to or dependent upon both I and Q components. Each received symbol (x, y), the corresponding LLR of each bit is computed as follows:

$$L L R ( {b}_{i} ) = log \frac{{\sum }_{{b}_{i} = 1} P ( s ( {b}_{i} ) \vert ( x , y ) )}{{\sum }_{{b}_{i} = 1} P ( s ( {b}_{i} ) \vert ( x , y ) )} for {b}_{0} , {b}_{1} , {b}_{2} , {b}_{3} and {b}_{4} \qquad ( 4 )$$

It should be noted that in Equation (4) the logarithmed element for both the top portion (numerator) and the bottom portion (denominator) entails sixteen items. For example, for LLR(bₒ), the top portion (numerator) items are based on the set of {Sₒ, S₂, S₄, S₆, S₈, S₁₀, S₁₂, S₁₄, S₁₆, S₁₈, S₂₀, S₂₂, S₂₄, S₂₆, S₂₈, S₃₀} and the bottom portion (denominator) items are the other 16. For each item in Equation (4), it needs to be calculated as follows:

$$P ( s ( {b}_{i} ) \vert x ) = \frac{1}{\sqrt{2 π} δ} exp [ - \frac{( {( s ( {b}_{i} , I ) - x )}^{2} + {( s ( {b}_{i} , Q ) - y )}^{2} )}{2 {δ}^{2}} ] \qquad ( 5 )$$

Where s(bᵢ, I) and s(bᵢ, Q) are the real and imaginary elements of s(bᵢ).

Obviously, this non-independent relationship makes the computation of LLR in 32-QAM much more complicated than that in 16QAM.

Features of 32-QAM Mapping

From FIG. 4, a few features or characteristics can be observed and gleaned therefrom. It is noted that the decimal numbers beside the star points from 0 to 31 correspond with the set of signal points {Sₒ, S₁, S₂, S₃, . . . , S₂₉, S₃₀, S₃₁}.

1) For 16 inner signal points within the dashed block 50, the 4 least significant bits (LSB), b₃ b₂ b₁ bₒ have the independent features as discussed in FIG. 3 relating to 16-QAM.

2) For the most significant bits (MSB) b₄, the 16 inner signal points corresponds to b₄=0 and the 16 outer signals (outside the dashed block) correspond to b₄=1.

3) We can define a 4-LSB counter point (CP) of a signal point as a signal point with the same 4-LSB bits but different MSB. For example, CP of S₃₀ is S₁₄ because both of them have the same 4-LSB 1110, but MSB is different. Among 16 outer signal points, 12 points have the same 4 LSB bits as its closest neighbor in I or Q axis. For the other 4 outer signal points, S₁₆, S₁₈, S₂₄ and S₂₆, their CP are not close. Their CPs are S₀, S₂, S₁₀ and S₈ respectively.

By utilizing these features, we can separate the LLR computation of MSB and 4-LSB and come out with a simplified method to compute the LLR.

Simplified LLR Computation for 32-QAM

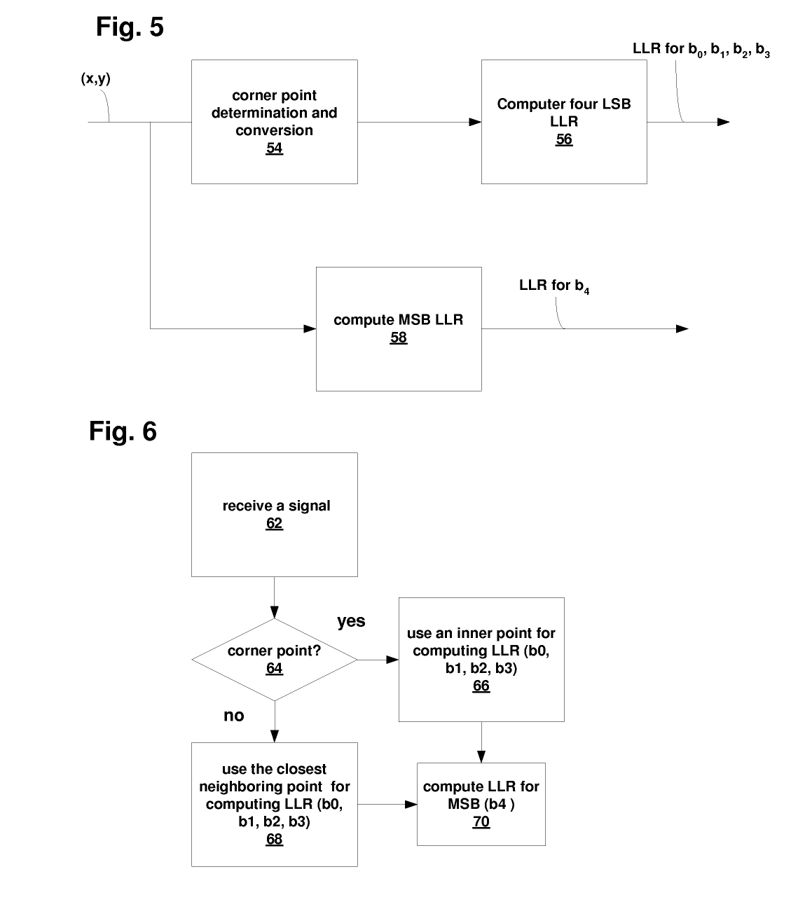

Referring to FIG. 5, a block diagram for computing the LLR of a 32QAM system is shown. The corner conversion block (CCB) 54 is first used to identity whether a received symbol (x, y) is in the nearby area or a predetermined neighborhood of S₁₆, S₁₈, S₂₄ and S₂₆ as shown in the hatched area in FIG. 4 (only one shown). For example, if x>4 and y>2, this received symbol is considered in the nearby area 52 of S₂₆. Then this corner symbol is converted, as shown by broken line 53, to the nearby area of a corresponding internal signal point, which is S₁₀ in this case.

After the CCB 54, the four LSB's LLR are computed 56. In the computation, the converted symbol or the original symbol when it is not a corner symbol is used to compute LLR for b₀, b₁, b₂ and b₃ 56. As shown supra, the computation of b0, b₁, b₂ and b₃ has the characteristic of having independent I and Q. The computation is given by Equation (3).

MSB is computed 58. For MSB, its LLR can be computed as

LLR(b₄)=−log [P(4|abs(x))+P(4|abs(y))/2.0] (6)

Where P(4|abs(x)) and P(4|abs(y)) are computed as Equation (5)

As can be seen, the complexity of the simplified method is greatly reduced as compared to the original method given by Equation (4). The performance of the simplified method is shown to be only 0.8 dB worse than that obtained by the original method.

Referring to FIG. 6, a flowchart 60 for computing the LLR of a 32QAM system having a 32-QAM mapping associated with a 16-QAM mapping. A signal (x, y) is received for LLR computation (Step 62). The computation of 32-QAM is split into two parts comprising a first part having 4-LSB and a part having a MSB. Divide the 32-QAM mapping into two subgroups comprising a first subgroup having the MSB equal to 1 and a second subgroup having the MSP EQUAL TO 0. For 4-LSB, identify whether the received symbol is a corner symbol (e.g. S₂₆). In other words, a step of determining whether the received signal (x, y) is in the neighborhood of a corner point (Step 64). For the corner symbol or the received signal in the vicinity of the corner point, the symbol is converted to a symbol related to an associated element within the inner block 52 of FIG. 4. That is to say, if the received signal (x, y) is in the neighborhood of a corner point, an inner point is used for computing the LLR of LSB (i.e. b0, b1, b2, b3) which is similar with the computation of a corresponding 16-QAM having the four bits b0, b1, b2, b3 (Step 66). In the present example, the inner point for S₂₆ is S₁₀. If the received signal (x, y) is not in the neighborhood of a corner point, the closest neighboring point within or without block 52 is used for computing LLR (b0, b1, b2, b3) (Step 68). In other words, for non-corner points, there are pairs having one point positioned within block 52 and the other point positioned outside block 52. The non-corner points of inner block 52 are positioned at a peripheral of the inner block 52. Some examples of the pairs are S₇-S₂₃, S₁₃-S₂₉, S₁₄-S₃₀, etc. As can be seen, only one computation of the four bits b0, b1, b2, b3 among a pair is needed because the computation of LLR (b0, b1, b2, b3) of the pair are identical. In turn, the LLR for 32-QAM MSB (i.e. b4) is computed separately (Step 70). The computed result is compared with the mapping or star points using the 32-QAM mapping as shown in FIG. 4 (Step 72).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for determining a characteristic of a computed LLR result comprising the steps of:
providing a 32-QAM mapping associated with a 16-QAM mapping with the 32-QAM mapping points having four least significant (LSB) bits and one most significant (MSB) bit;
simplifying the computation of the four least significant (LSB) bits by using at least one characteristic of a pairing; and
determining a received signal position in the mapping by associating the value of the received signal with a point in the 32-QAM mapping.

2. The method of claim 1 further comprising the step of, for the 32-QAM mapping, forming two groups comprising a first group with a first MSB and a second group with a second MSB.

3. The method of claim 1 further comprising the step of splitting the computation of the 32-QAM mapping into two parts including a first part having the 4-LSB bits and a second part having the single MSB bit.

4. The method of claim 1 further comprising the step of, for 4-LSB, identifying whether the received symbol is a corner symbol.

5. The method of claim 4 further comprising the step of converting a corner symbol to a symbol related to an associated element within an inner block.

6. The method of claim 4 further comprising the step of converting a non-corner symbol to a symbol related to an associated element at a peripheral of the inner block if the non-corner symbol is outside the inner block, or vice versa.

7. The method of claim 1 further comprising the step of computing the MSB of 32-QAM.

8. The method of claim 1 further comprising the step of comparing the computed result using the 32-QAM mapping.
